(19) United States
(12) Patent Application Publication
(10) Pub. No.: US 2023/0271591 A1
(43) Pub. Date: Aug. 31, 2023

(54) Simplified Multi-Part Refueling Device

(71) Applicant: Tecflower AG, Siebnen (CH)

(72) Inventors: Sascha Reinger, Siebnen (CH); Galina Riegel, Siebnen (CH)

(73) Assignee: Tecflower AG, Siebnen (CH)

(21) Appl. No.: 17/740,592

(22) Filed: May 10, 2022

(30) Foreign Application Priority Data
Feb. 28, 2022 (CH) 000197/2022

(51) Int. Cl. B60S 5/02; B60L 53/12; B60L 53/38; B60L 53/37; B60K 15/04; B25J 13/08; B25J 18/02; B25J 9/16

(52) U.S. Cl. CPC B60S 5/02; B60L 53/12; B60L 53/38; B60L 53/37; B60K 15/04; B25J 13/089; B25J 18/025; B25J 9/1687

(57) ABSTRACT

In a multi-part refueling device for refueling an electric drive battery or a fluid tank of a movable vehicle, simplified, reproducible refueling is to be achieved. The object is achieved in that the vehicle-side coupling device carried on the vehicle has connecting means designed as at least one charging coil, charging contacts or as a loading nozzle and also has a manipulator arm for descending, displacing and lowering the contact plate in a center of the stationary ground coupling device, wherein the manipulator arm comprises an upper arm segment pivotally and rotatably mounted on the vehicle side, a joint, a lower arm segment and a further joint for mounting the contact plate and is automatically controlled by the computer and control unit.

### FIELD OF THE INVENTION

The present invention describes a multi-part refueling device for refueling an electric drive battery or a fluid tank of a movable vehicle, comprising: a vehicle-side coupling device with a charging connection, a computer and control unit, a contact plate connection and a movable contact plate with connecting means; and a ground coupling device arranged stationary and fixed on the ground with at least one charging coil, with charging contacts or a tank nozzle, which are compatible with the selected connecting means. The present invention also describes a refueling method using a multi-part refueling device for refueling an electric drive battery or a fluid tank of a movable vehicle.

### PRIOR ART

Devices and corresponding methods for charging drive batteries of vehicles such as electric vehicles or hybrid vehicles with an electric drive are known in various variants. Above all, the simplicity and user-friendliness are the main characteristics to be developed. At best, the vehicle is simply navigated to a specific position and charged there by manually operating a multi-part refueling device. Usually a user has still to adjust various settings manually. The drive battery is then charged from a power supply network with or without further action on the part of the user.

A multi-part refueling device is known from DE102014221998, which focuses on wireless, inductive charging of the drive battery. An engine-side or vehicle-side coupling device with a charging coil is coupled to a stationary ground coupling device, the charging coil being coupled to a charging coil as part of the ground coupling device, which is supported on the ground. The charging coil or primary coil is usually mounted on the ground of a garage and connected to charging electronics so that an electromagnetic charging field can be generated. As soon as the charging coil or secondary coil is in the electromagnetic charging field of the charging coil, the drive battery can be inductively charged. The movement of the charging coil takes place at ground level. Both coils act as electromagnets, which attract and urge towards each other, depending on the induced current or magnetic field. According to DE102014221998, sufficiently efficient inductive charging should be achievable, corresponding to an optimal alignment of the secondary coil to the primary coil, without a great deal of maneuvering effort.

The position optimization was achieved by moving the primary coil as part of the ground coupling device, by linear displacement, rotation and/or tilting. Positioning signals should be acquired during positioning to achieve adjustment of the primary coil relative to the secondary coil. Based on the positioning signals, adjusting means of the primary coil are necessary in order to optimize the electromagnetic coupling so that, with ever-increasing amounts of energy, lower energy losses and the lowest possible electromagnetic emissions affect the surroundings.

The solution from DE102014221998 requires not only sensors and actuating means but also control electronics for acquiring the sensor data and corresponding feedback positioning of the primary coil on the ground side. This positioning could, of course, also be trained and automated, but this requires an even greater and more complex electronic means and software, which makes the positioning more expensive and also more fault-prone. The complex electromechanics must be embedded in the ground and mounted there so that they can be moved.

### DESCRIPTION OF THE INVENTION

A simplified, reproducible and secure positioning of a vehicle-side coupling device relative to the ground coupling device shall be provided herein, which object is achieved by comparatively simple means and enables fully automatic, maintenance-free and less fault-prone refueling of drive batteries as well as fluid tanks.

Variations of combinations of features or minor adaptations of the invention can be found in the detailed description, are illustrated in the figures and are included in the dependent claims.

### BRIEF DESCRIPTION OF THE DRAWINGS

A preferred embodiment of the subject matter of the invention is described below in connection with the accompanying drawings.

In particular

FIG. 1a shows a schematic top view of the multi-part refueling device with a vehicle, the front axle of which has been partially moved onto the stationary ground coupling device, the vehicle-side coupling device still being attached to the underside of the vehicle in the storage state.

FIG. 1b shows a schematic view of the front end of the vehicle from FIG. 1a, a contact plate of the vehicle-side coupling device 2 being lowered onto the ground and moved towards the center of the ground coupling device.

FIG. 2 shows a sectional view of the multi-part refueling device, the contact plate being lowered onto the ground, moved with a displacement mechanism and connecting means of the contact plate being brought into a refueling position on the stationary ground coupling device by means of a lowering mechanism.

FIG. 3 shows a schematic partial section view of a further embodiment of the multi-part refueling device.

### SPECIFICATION

A multi-part refueling device 1 is described herein, which comprises a vehicle-side coupling device 2 and a stationary ground coupling device 3. The vehicle-side coupling device 2 is attached to an underside of a vehicle and can be carried with the vehicle. Only two wheels, the wheel suspension, a drive battery A and a fluid tank B are shown here. The multi-part refueling device 1 is intended to provide the simplest possible fully automatic refueling of the drive battery A with electricity or of the fluid tank B with a fluid, for example a combustion gas.

A charging coil 30, a charging contact 30 or a tank nozzle 30 is arranged in the center of the ground coupling device 3, is supplied with electricity or a fluid by means of a supply line 31 and can be operated in a controlled manner by means of charging electronics 32 of the stationary ground coupling device 3.

The vehicle-side coupling device 2 is connected via a charging connection 20, which is formed by at least one electric cable, to the drive battery A, or which is formed by a hose, to the fluid tank B, and has a computer and control unit 21 and a contact plate 23 that can be lowered from the vehicle towards the ground. A contact plate connection 22 can be seen in FIG. b and can accordingly be formed by at least one electric cable or one fluid hose.

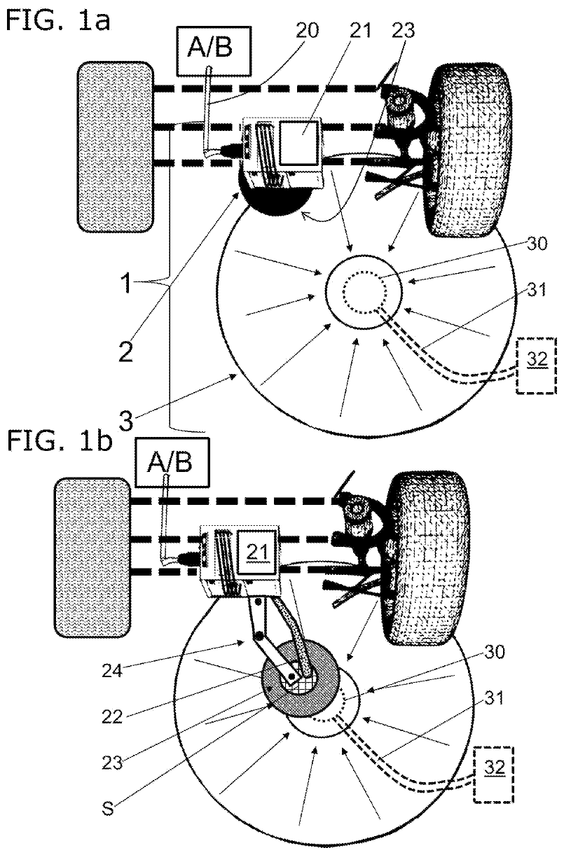

By means of a manipulator arm 24, indicated in FIG. 1b, controlled by the computer and control unit 21, the contact plate 23 can be lowered from the vehicle towards the ground for refueling, until the ground below. Also by means of the manipulator arm 24, which is suitably configured, the contact plate 23 can be displaced to the center of the stationary ground coupling device 3, in the direction of the arrows, as close as the manipulator arm 24 or the contact plate connection 22 allows. The transmission of the electric current or the nozzle connection of the fluid hoses is optimal at the center.

After the contact plate 23 has been lowered and moved simultaneously or with a time delay, the contact plate 23 as a whole with connecting means 230 arranged thereon is lowered flush to the ground.

After the vehicle has been parked in the vicinity of the ground coupling device 3, the contact plate 23 on or in which the connecting means 230 are located is placed as far as possible in the center of the stationary ground coupling device 3, with contact to the charging coil 30, the charging contacts 30 or the tank nozzle 30. For this purpose, the manipulator arm 24 is sufficient, which can be moved in an automated manner electromechanically or pneumatically, controlled by the computer and control unit 21.

In order to automate the control of the manipulator arm 24, at least one sensor S is arranged on the contact plate 23, which is arranged here in the center of the contact plate 23. Various embodiments of the sensor S are possible, such as an electromagnetic or magnetic sensor, as well as optical sensors in the visible range or in the infrared range or a purely mechanical contact sensor. A corresponding counterpart of the selected sensor S can be attached to the ground coupling device 3 for support.

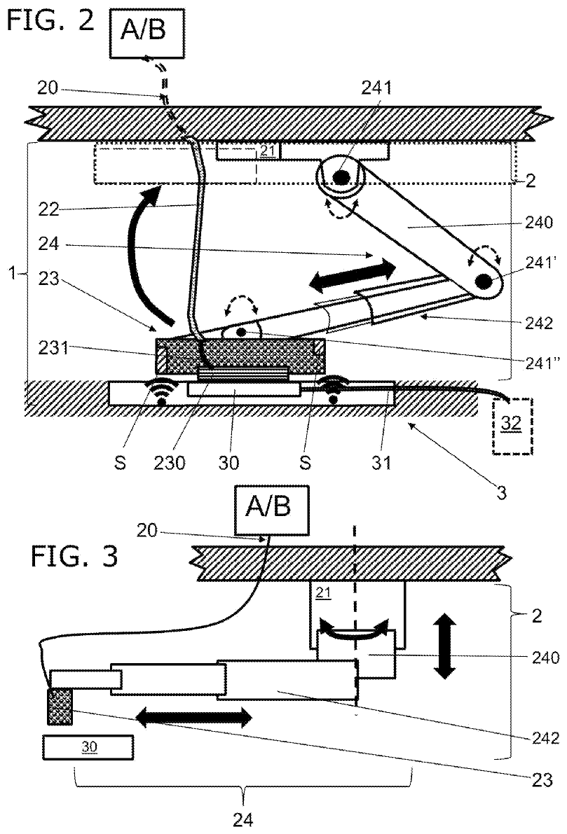

FIG. 2 partially shows a vehicle underbody is partially shown, on which the vehicle-side coupling device 2 is arranged, wherein the computer and control unit 21 allows the contact plate 23 to be descended and the contact plate 23 to be moved selectively into the immediate vicinity of the charging coil 30, the charging contacts 30 or the tank nozzle 30. The manipulator arm 24 and the contact plate 23 attached to it are automatically released, lowered and controlled laterally to the ground by the computer and control unit 21. In essence, the manipulator arm 24 here comprises an upper arm segment 240 pivotally and rotatably mounted on the vehicle side. Attachment of the upper arm segment 240 is achieved by a joint 241 on the underside of the vehicle.

Another joint 241′ is arranged at the end of the upper arm segment 240 facing away from the vehicle side. A lower arm segment 242 is pivotally attached to the joint 241. The contact plate 23 is attached to the free end of the lower arm segment 242 via a further joint 241″, and here too there should be a certain degree of swivel movement to enable the contact plate 23 to be placed parallel on the around coupling device 3. By means of the computer and control unit 21, the manipulator 24 can be moved in the space between the underside of the vehicle and the ground in such a way that the contact plate 23 reaches a maximum range.

The manipulator arm 24 may be electrically, electromechanically or pneumatically controlled by the computer and control unit 21.

During the descending and moving of the manipulator arm 24, the contact plate 23 is moved to the location with optimal current or fluid transmission on the ground coupling device 3 based on the sensors S.

At the center of the stationary ground coupling device 3, alternating electromagnetic fields, an electric current or the fluid can optimally flow from the charging coil 30, the charging contacts 30 or the tank nozzle 30 into the contact plate 23 or into the connecting means 230 in the form of at least one charging coil 230, two charging contacts 230 or at least one loading nozzle 230, while the refueling process is started. An electric cable 231 or a loading hose 231 leads from the connecting means 230 to the contact plate connection 22 and thus indirectly via the charging connection 20 to the drive battery A or to the fluid tank B.

In order to allow for fully automatic refueling, the optimal position of the contact plate 23 must be found with at least one sensor S through the charging coil 30, the charging contacts 30 or the tank nozzle 30 and the manipulator arm 24 must be moved thereto.

In FIG. 2, the retracted state of the manipulator arm 24 with contact plate 23 is shown in dashed lines. The folding of the manipulator arm 24 is indicated by the single arrow. The design of the manipulator arm 24 must be such that the contact plate connection 22 is not severed during movement.

In order to further increase the travel range of the manipulator arm 24 or the contact plate 23, the lower arm segment 242 is optionally designed here as a linearly extendable telescopic segment. This telescopic segment can be retracted and extended along the double arrow, allowing the contact plate 23 to be optimally moved to the center of the stationary ground coupling device 3. The telescopic segment 242 can be moved by the computer and control unit 21 under electrical, electromechanical or pneumatic control.

It is crucial that no movable components are used in the stationary ground coupling device 3 and that the supply line 31 and the charging coil, the charging contacts or the tank nozzle 30 are fixed in a stable manner, Refueling can even function without charging electronics 32 if the supply line 31 is always supplied with electricity or fluid.

As soon as the connecting means 230 are connected to the charging coil 30, the charging contacts 30 or the tank nozzle 30, refueling can begin.

Electrical charging of the drive battery A can be achieved by means of wire-bound charging through contact between two charging contacts 230 and charging contacts 30 or by means of wireless charging through contact between a charging coil 230 and a charging coil 30.

If the fluid tank B is to be refueled in the vehicle, a closing contact between the charging port 230 on the contact plate 23 and a tank nozzle 30 on the stationary ground coupling device 3 must be achieved.

The contact plate 23 is preferably designed as a multi-layer housing and has an interior space in which the connecting means 230, sensors S can be arranged.

In order to carry out the refueling method, in a first step, the vehicle must be parked by a vehicle driver in the area of the stationary ground coupling device 3. Here, the vehicle-side coupling device 2 is arranged in the area of the front axle of the vehicle, and the stationary ground coupling device 3 is positioned approximately between the front wheels. Since the ground coupling device 3 is fixed, the vehicle must be positioned accordingly.

Once the vehicle is in place, the computer and control unit 21 can be started and the desired refueling process is started. Accordingly, an operating option for the computer and control unit 21 should be set up on the dashboard of the vehicle. Controlled by the computer and control unit 21, the contact plate 23 is lowered with the manipulator arm 24 from the vehicle until it conies into contact with the ground coupling device 3.

The contact plate 23 is then moved by means of the manipulator arm 24 in the direction of the optimal refueling point of the stationary ground coupling device 3. Controlled by the at least one sensor S, the manipulator arm 24 finds the best position for the contact plate 23 so that the connecting means 230 are brought at a minimum distance from the charging coil 30, the charging contacts 30 or the tank nozzle 30.

At the end, the contact plate 23 together with the connecting means 230, controlled by the computer and control unit 21, is automatically set down, as a result of which the connecting means 230 are coupled to the charging coil 30, the charging contacts 30 or the tank nozzle 30.

If the supply line 31 is constantly supplied with electricity or fluid, the refueling process can begin immediately. The computer and control unit 21 can also be used to monitor the refueling.

If the stationary ground coupling device 3 includes the charging electronics 32, then the refueling process can be started accordingly by the charging electronics 32 and ended again after completion. In this case, the charging electronics 32 ensure automatic refueling and termination of the process.

After refueling has been completed, the connecting means 230 are released again from the stationary ground coupling device 3 and the manipulator arm 24 together with the contact plate 23 are moved back to the storage state on the vehicle floor.

When the charging electronics 32 are used, it can be ensured that the power supply and fluid supply only take place when the refueling process has started, which is preferred for safety and environmental reasons.

In a further embodiment shown in FIG. 3, the coupling device 2 carried on the vehicle includes connecting means not shown here in the form of at least one charging coil, in the form of charging contacts or as loading nozzles. The entire manipulator arm 24 is connected to the computer and control unit 21 and can be descended as a whole in the direction of the stationary ground coupling device 3. The upper arm segment 240 including the telescopic lower arm segment 242 on the manipulator arm 24 is configured such that it can be lowered and rotated 360° about a longitudinal axis, while the lower arm segment 242 can be moved in a plane such that linear displacement of the contact plate 23 to various locations near the center of stationary ground coupling device 3 can take place. A mechanism is provided which engages the upper arm segment 240 to raise and lower the entire manipulator arm 24 and rotate it about its longitudinal axis. The lower arm segment 242 is designed to be telescopic and includes a plurality of parts which are movable in a longitudinal direction according to the double arrow. The contact plate 23 is arranged on the side spaced from the upper arm segment 240 at the end of the lower arm segment 242, is moved rotatably, pivotably or linearly displaceably by the mechanism and the telescopic lower arm segment 242, the movements being automatically controlled by the computer and control unit (21).

### LIST OF REFERENCE NUMERALS

A drive battery (electric vehicle/hybrid vehicle)
B fluid tank
1 multi-part refueling device
2 vehicle-side coupling device
20 charging connection
21 computer and control unit (for positioning and partly as charge controller)
22 contact plate connection (fluid hose or electric cable)
23 contact plate
230 connecting means=charging coil/charging contact/loading nozzle
231 electric cable/loading hose
S sensor (electromagnetic/magnetic/optic (visible spectrum/infrared), contact sensors)
24 manipulator arm (at least one segment)
240 upper arm segment
241, 241′, 241″ joints
242 lower arm segment (telescopic segment, linearly extendable)
3 stationary ground coupling device
30 charging coil/charging contacts/tank nozzle
31 supply line (electric current/fluid)
32 charging electronics

1. A multi-part refueling device for refueling an electric drive battery or a fluid tank of a movable vehicle, comprising:
a vehicle-side coupling device with a charging connection, a computer and control unit, a contact plate connection designed as an electric cable or fluid hose and a movable contact plate with connecting means, and
a ground coupling device arranged in a stationary and fixed manner on the ground with at least one charging coil, with charging contacts or a tank nozzle, which are compatible with the selected connecting means,
wherein
the vehicle-side coupling device carried on the vehicle includes connecting means designed as at least one charging coil, in the form of charging contacts or as loading nozzles, and a manipulator arm for descending, displacing and lowering the contact plate in a center of the stationary ground coupling device,
wherein the manipulator arm is mounted so that it can be moved up and down, has at least one upper arm segment pivotally and rotatably mounted on the vehicle side and one telescopic lower arm segment for mounting the contact plate, and is automatically controlled by the computer and control unit.

2. The multi-part refueling device of claim 1, wherein the manipulator arm includes the upper arm segment pivotally and rotatably mounted on the vehicle side, a joint, a lower arm segment and a further joint for mounting the contact plate, and is automatically controlled by the computer and control unit.

3. The multi-part refueling device of claim 2, wherein the upper arm segment of the manipulator arm is pivotally attached to a joint on the vehicle side.

4. The multi-part refueling device of claim 2, wherein the lower arm segment is designed as a telescopic segment that can be moved electrically, electromechanically or pneumatically controllably by the computer and control unit and can thus be extended linearly.

5. The multi-part refueling device of claim 1, wherein the manipulator arm is designed to be electrically, electromechanically or pneumatically controlled by the computer and control unit.

6. The multi-part refueling device of claim 1, wherein at least one sensor is arranged on the contact plate or in the inner space of the contact plate and is connected to the computer and control unit for determining the optimal position relative to the stationary ground coupling device, wherein the at least one sensor is a contact sensor, an electromagnetic sensor, a magnetic sensor, an optical sensor or an infrared sensor.

7. The multi-part refueling device of claim 1, wherein the stationary ground coupling device comprises charging electronics which starts and ends the refueling process, wherein an electric current or a fluid are correspondingly fed in a controlled manner.

8. A refueling method using a multi-part refueling device for refueling an electric drive battery or a fluid tank of a movable vehicle, comprising the steps of:
providing the multi-part refueling device of claim 1,
positioning the vehicle in the vicinity of a locally fixed immovable ground coupling device,
operating a computer and control unit to start the refueling process,
lowering of a contact plate in the direction of the ground coupling device on the ground beneath the vehicle by means of a manipulator arm electrically, electromechanically or pneumatically controlled by the computer and control unit in such a way that connecting means of the contact plate are brought to a minimum distance from a charging coil, charging contacts or a tank nozzle of the ground coupling device,
starting the refueling process by applying electricity to the charging coil or the charging contacts or by supplying fluid to the tank nozzle, and after the refueling, and
transferring the contact plate back into a storage state by means of the manipulator arm.

9. The refueling method of claim 8, wherein the manipulator arm includes the upper arm segment pivotally and rotatably mounted on the vehicle side, a joint, a lower arm segment and a further joint for mounting the contact plate, and is automatically controlled by the computer and control unit.

10. The refueling method of claim 8, wherein the upper arm segment of the manipulator arm is pivotally attached to a joint on the vehicle side.

11. The refueling method of claim 9, wherein the lower arm segment is designed as a telescopic segment that can be moved electrically, electromechanically or pneumatically controllably by the computer and control unit and can thus be extended linearly.

12. The refueling method of claim 8, wherein the manipulator arm is designed to be electrically, electromechanically or pneumatically controlled by the computer and control unit.

13. The refueling method of claim 8, wherein at least one sensor is arranged on the contact plate or in the inner space of the contact plate and is connected to the computer and control unit for determining the optimal position relative to the stationary ground coupling device, wherein the at least one sensor is a contact sensor, an electromagnetic sensor, a magnetic sensor, an optical sensor or an infrared sensor.

14. The refueling method of claim 8, wherein the stationary ground coupling device comprises charging electronics which starts and ends the refueling process, wherein an electric current or a fluid are correspondingly fed in a controlled manner.
